(19) United States
(12) Patent Application Publication
(10) Pub. No.: US 2016/0035009 A1
(43) Pub. Date: Feb. 4, 2016

(54) System and Method for Providing On-Demand Service Advertising

(71) Applicant: Anwar M. Khrawish, Wood Dale, IL (US)

(72) Inventor: Anwar M. Khrawish, Wood Dale, IL (US)

(21) Appl. No.: 14/561,913

(22) Filed: Dec. 5, 2014

Related U.S. Application Data
(60) Provisional application No. 62/032,023, filed on Aug. 1, 2014.

(51) Int. Cl. G06Q 30/06; G06Q 30/02; G06Q 10/06

(52) U.S. Cl. CPC G06Q 30/0635; G06Q 10/063114; G06Q 30/0259; G06Q 30/0282

(57) ABSTRACT

A system and method for providing on-demand service advertising, wherein a customer can select a particular service derived from a display of service categories. A selected category is chosen from the service categories to reveal specific services from which the particular service can be selected. Once selected, location data for available employees is displayed to the customer, wherein the customer can select a specific employee for the particular service. The specific employee can choose to accept or decline a service request from the customer. If the service request is accepted, a job accepted notification is sent to the customer and the specific employee begins the job. A job commencement notification and a job completion notification are sent to the customer upon start and finish of the job respectively. The customer can then provide an employee rating for the specific employee, and the specific employee a customer rating for the customer.

The current application claims a priority to the U.S. Provisional Patent application Ser. No. 62/032,023 filed on Aug. 1, 2014.

### FIELD OF THE INVENTION

The present invention relates generally to applications for mobile devices. More specifically, the present invention relates to a system and method of advertising on-demand, location-based services.

### BACKGROUND OF THE INVENTION

Traditionally, people have had to rely on phone books or local advertisements through newsprint and television to find nearby services. With the surge of mobile electronic devices like smartphones and tablet computers that utilize global positioning system (GPS) or other location-based technologies, finding nearby services has become vastly easier. If a person wishes to request home services (plumbing, heating/cooling, etc.), transportation services (taxis, airport shuttles, etc.), road services (auto glass, tow trucks, etc.) or any other service, they may only need to search for basic names of these types of services on their mobile device through an Internet search engine. Some search engines may provide the search results on an interactive map showing the physical location of the desired service provider.

However, this only allows a person, or potential customer, to view the location of the service provider. For a service where the service provider sends an employee out to the customer's location, this method is not efficient. The customer may have to manually call or e-mail the service provider and give his or her location, at which point an employee is selected by the service provider to respond to the customer's service request. The employee selected to respond to the customer may not necessarily be in the near vicinity of the customer, which may further slow the process.

There is a need for a system that allows customers to access any on-demand, location-based services quickly. Therefore it is an object of the present invention to provide a system and method for providing on-demand advertising through which customers may automatically and directly select employees of service providers to respond to their service requests. The system of the present invention also utilizes the GPS of modern personal electronic devices to allow customers to select employees who are nearest to the customer's current location. The system additionally gives both customers and employees the option to accept or reject service requests. Customer and employee ratings are provided for customers and employees respectively, to encourage fair treatment on both ends and provide insight to potential jobs and customer interactions.

### BRIEF DESCRIPTION OF THE DRAWINGS

FIG. 1 is a diagram depicting the network communications between administration devices, service provider devices, employee devices, and customer devices.

FIG. 2 is a flowchart depicting interactions between the customer side and the employee side;

FIG. 3 is a flowchart thereof, further depicting the use of location data to show the global position of employees and customers;

FIG. 4 is a flowchart thereof, further depicting customer and employee interactions once a service request has been accepted or declined by the employee;

FIG. 5 is a flowchart thereof, further depicting employee interactions to toggle the employee status to offline, wherein the location of the employee is hidden from customers; and

FIG. 6 is a flowchart thereof, further depicting employee interactions to toggle the employee status to online, wherein the location of the employee is displayed to customers.

FIG. 7 is a flowchart depicting the process carried out on the customer side in order to initiate a service request.

FIG. 8 is a flowchart depicting the process carried out on the customer side once a service request has been accepted by an employee.

FIG. 9 is a diagram depicting the user interface on the customer side for signing into a customer account.

FIG. 10 is a diagram depicting the display of service categories through the customer account.

FIG. 11 is a diagram depicting the display of specific services from a selected category of the service categories through the customer side.

FIG. 12 is a diagram depicting the display of location data for available employees for a particular service selected from the specific services.

FIG. 13 is a diagram depicting the profile page for the nearest available employee for the particular service.

FIG. 14 is a diagram depicting the display of available employees for the particular service.

FIG. 15 is a diagram depicting the display of the employee work time through the customer side once the customer has received a job commencement notification.

FIG. 16 is a diagram depicting location data for both the customer and the employee through the customer side, wherein the service request can be cancelled.

FIG. 17 is a diagram depicting a ratings page for the employee, wherein the customer can provide an employee rating for the employee.

FIG. 18a is a flowchart depicting the process carried out on the employee side once the service request has been initiated by the customer; and

FIG. 18b is a flowchart thereof.

FIG. 19 is a diagram depicting a profile options page for an employee account, displayed through the employee side.

FIG. 20 is a diagram depicting the employee profile page through the employee side.

FIG. 21 is a diagram depicting location data for the employee once the employee status has been changed to online.

FIG. 22 is a diagram depicting the option to accept or decline a service request that has been initiated by a customer.

FIG. 23 is a diagram depicting location data for the employee and customer through the employee side once the employee has accepted the service request.

FIG. 24 is a diagram depicting the display of the employee work time through the employee side once the job commencement notification has been sent to the customer.

FIG. 25 is a diagram depicting a ratings page for the customer, wherein the employee can provide a customer rating for the customer.

FIG. 26 is a diagram depicting the user interface of the service provider side for adding a new employee to the system.

FIG. 27 is a diagram depicting the user interface of the service provider side for managing registered employees.

### DETAIL DESCRIPTIONS OF THE INVENTION

All illustrations of the drawings are for the purpose of describing selected versions of the present invention and are not intended to limit the scope of the present invention.

The present invention is a system and method for providing on-demand service advertising. The system of the present invention provides the hardware and software necessary for carrying out the method of the present invention. The hardware includes networking devices, such as servers, routers, personal computing devices, etc. The software provides a means for managing an administration account, a plurality of service provider accounts, a plurality of employee accounts, and a plurality of customer accounts across the hardware; the hardware including a plurality of administration devices, a plurality of service provider devices, a plurality of employee devices, and a plurality of customer devices.

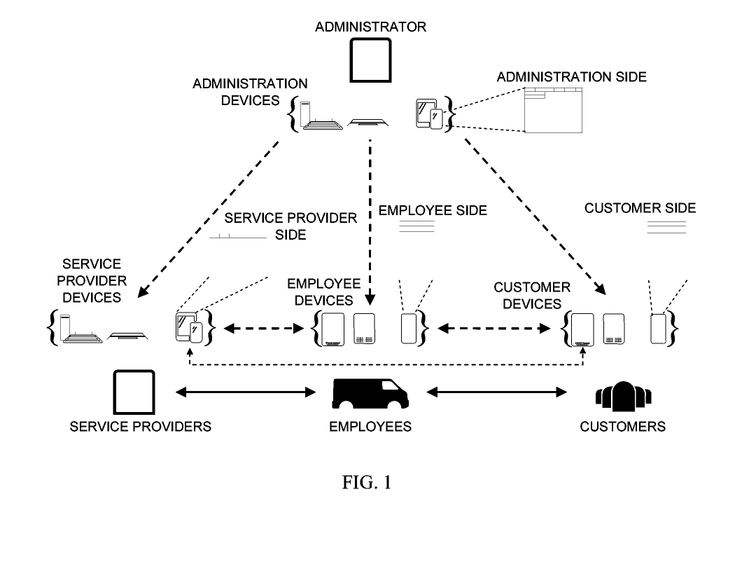

In reference to FIG. 1, the on-demand service advertising software is operated on the administration devices, the service provider devices, the employee devices, and the customer devices, which are connected via a network such as the Internet or any other wireless communication network. These devices are personal electronic devices with Internet access (or other wireless communication connectivity), such as desktop computers, laptop computers, tablet computers, and smartphones. Additionally, devices such as the employee devices and the customer devices may have global positioning system (GPS) capability (or other location detection means). Accordingly, the on-demand service advertising software is preferably implemented as a mobile device software application and/or a website.

The on-demand service advertising software, controlled by an administrator, provides an application and/or website through which customers may request on-demand services from various service providers. Services displayed to the customers are based on the physical proximities of the customers to both the service providers and the employees of the service providers as determined by the GPS location of each of the customers and the employees, or other location detection means. The administrator is an entity that owns and controls the on-demand service advertising software and the administration devices, such as servers, routers, etc. The customers may be any user of the on-demand service advertising system who wishes to receive a service. The service providers may be a company or any other business entity that provides services. The employees are employees of the service providers who carry out specific services 52 requested by the customers.

FIG. 1 is a schematic diagram of how the administrator, the service providers, the employees, and the customers interact using the on-demand service advertising system. The administrator, the service providers, the employees, and the customers each own personal electronic devices as previously explained. The administrator accesses an administration side 10 of the on-demand service advertising software through the administration devices. Likewise, the service providers access a service provider side 20 of the on-demand service advertising software through the service provider devices; the employees access an employee side 33 of the on-demand service advertising software through the employee devices; and the customers access a customer side 42 of the on-demand service advertising software through the customer devices.

A graphical user interface (GUI) is implemented to allow the administrator, the service providers, the employees, and the customers to view and control the respective sides of the on-demand service advertising software. On a device like a desktop or laptop computer, the GUI may be operated through a keyboard or mouse. Devices like smartphones and tablet computers will allow the GUI to be operated tactilely through touch screens and/or mechanical controls.

In reference to FIG. 1, the administrator is able to control various aspects of the service provider side 20, the employee side 33, and the customer side 42 of the on-demand service advertising software through the interaction of the administration devices with the service provider devices, the employee devices, and the customer devices over the network. However, the service provider side 20, the employee side 33, and the customer side 42 of the on-demand service advertising software are not configured to permit their respective users to control any aspects of the administration side 10 of the on-demand service advertising software.

In further reference to FIG. 1, the service providers and the employees of each of the service providers share information with each other via interaction of the service provider side 20 with the employee side 33. Likewise, the employees and the customers share information with each other via interaction of the employee side 33 with the customer side 42. While the customer side 42 primarily interacts with the employee side 33, in some cases the customer side 42 may additionally share information directly with the service provider side 20. In all cases, these interactions are enabled through communication of the service provider devices, the employee devices, and the customer devices over the network.

Typically, the service providers may be stationed at one or more stationary locations, such as in an office building. The service providers may interact physically with their employees, who may travel between their service provider location and various customer 40 locations via transportation means. Transportation means can include any mode of travel such as walking, bike, car, commercial van, truck, and the like.

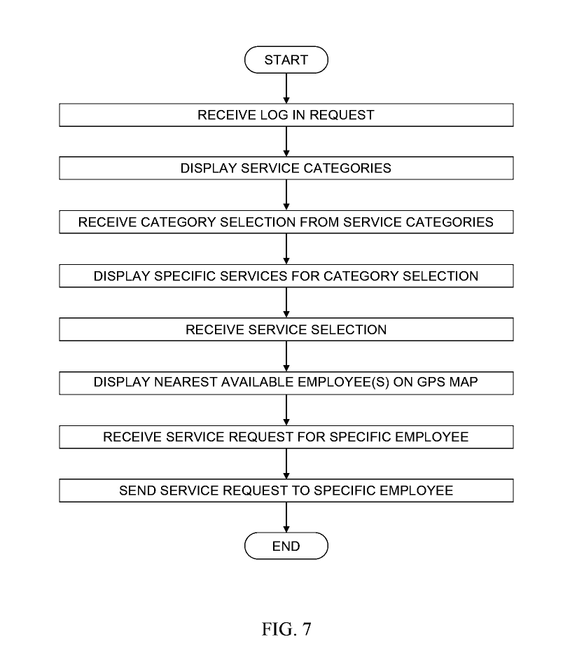

In reference to FIG. 7, the process for providing on-demand service advertising is initiated by a customer 40. FIG. 7 is a flow chart illustrating the process carried out by the customer 40 through the customer side 42 of the on-demand service advertising software. The process carried out by the customer 40 generally involves: receiving a log in request from the customer 40; displaying a plurality of service categories 50 available through the system; receiving a category selection for a selected category 51 from the service categories 50 from the customer 40; displaying a plurality of specific services 52 organized under the selected category 51; receiving a service selection for a particular service 53 from the specific services 52 from the customer 40; displaying a plurality of available employees 30 of the service providers who provide the particular service 53 on a GPS enabled map; receiving a service request for a specific employee 31 from the available employees 30, selected by the customer 40, to carry out the particular service 53; and sending said service request to the specific employee 31.

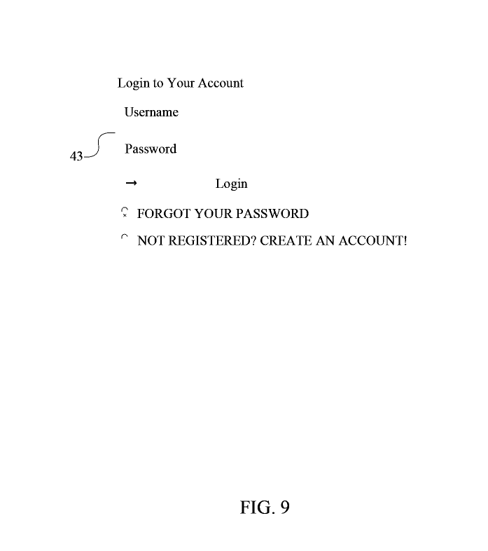

When accessing the customer side 42 of the on-demand service advertising software through the customer 40 device, the customer 40 will be required to either sign up for a customer account 41 or log into the customer account 41 previously created, as shown in FIG. 9. If the customer 40 is accessing the customer side 42 for the first time, he or she will be required to sign up with the system by supplying customer identification information 43, such as that outlined in FIG. 9. Upon submitting the customer identification information 43 for the customer 40, the customer account 41 is registered. In the preferred embodiment of the present invention, the customer identification information 43 includes a valid e-mail address (or other identification string) and a password, and may additionally include a name, address, city, state, postal code, primary and secondary phone numbers, or a digital photo of the customer 40. The customer 40 may also be required to accept a terms of use agreement as determined and edited by the administrator. Once the customer account 41 is registered, the customer 40 will be able to view and edit the customer identification information 43 at any time by pressing an info button. There may also be provided a help button that allows the customer 40 to view information about the on-demand service advertising system.

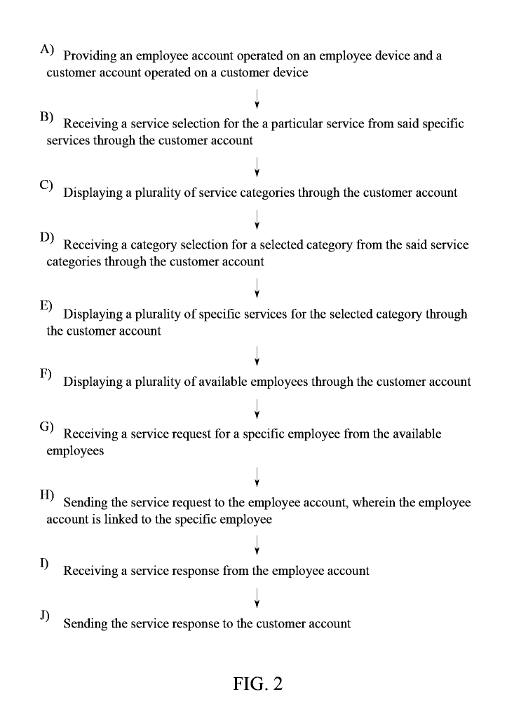

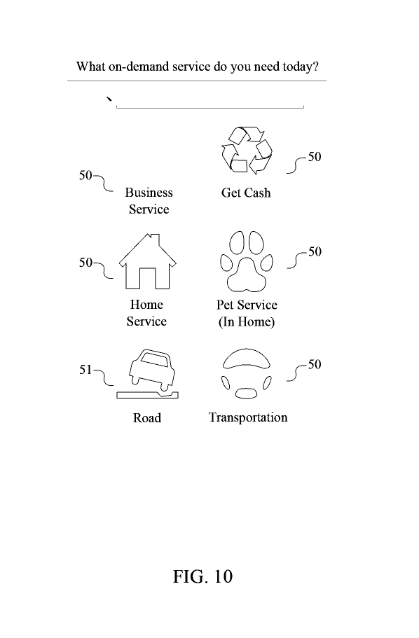

If the customer account 41 has been registered, then the customer 40 can log into the customer account 41 at any time by entering the valid e-mail address and the password initially supplied upon signing up. In reference to FIG. 2, once the customer 40 is logged in, the plurality of service categories 50 for the various services available through the system is displayed through the customer account 41. As shown in FIG. 10, each of the service categories 50 defines a different industry or type of service such as, but not limited to, transportation, road-side service, home service, and business service. Each of the service categories 50 may be added, removed, or edited at will by the administrator through the administration side 10. The customer 40 may select a category from the service categories 50 corresponding to the type of service he or she wishes to receive.

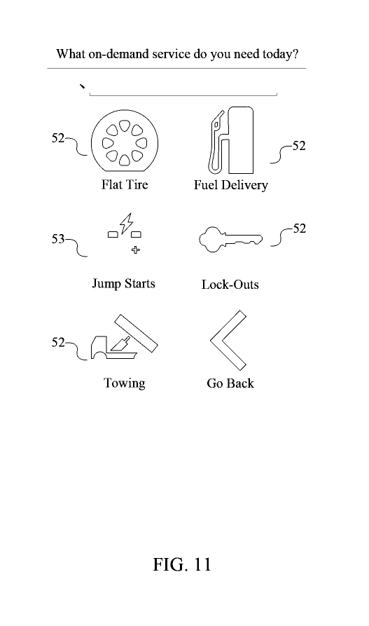

In further reference to FIG. 2, once the category selection is received through the customer account 41, each of the specific services 52 that fall under the selected category 51 is displayed through the customer account 41, as shown in FIG. 11. Each of the specific services 52 is a more specific type of service within the selected category 51, wherein the customer 40 can select the particular service 53 of interest. Examples of the specific services 52 that may be available through the on-demand service advertising system are shown pictorially in FIG. 11. Similar to the service categories 50, each of the specific services 52 may be added, removed, or edited at will by the administrator through the administration side 10.

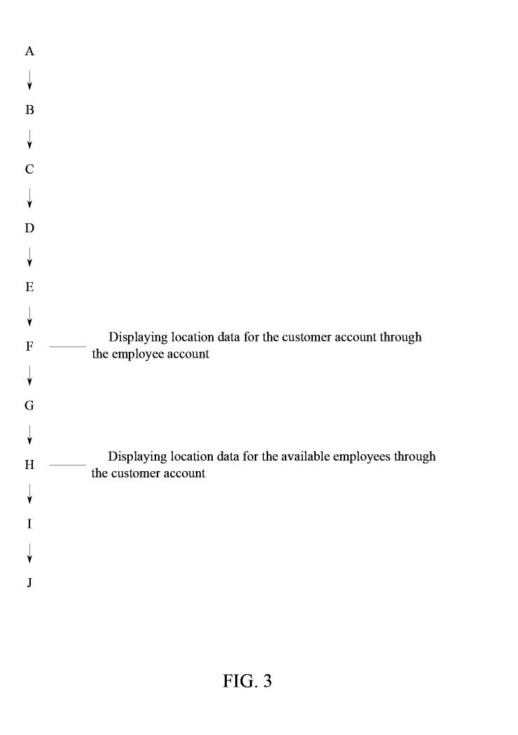

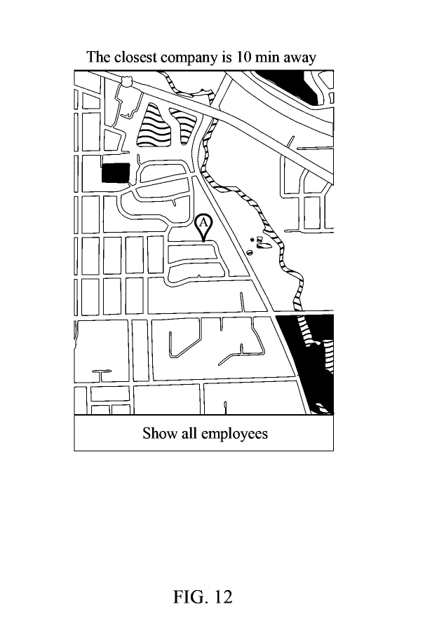

In reference to FIG. 2-3, once the service selection for the particular service 53 is received through the customer account 41, the available employees 30 for the particular service 53 is sent to the customer account 41. More specifically, the location data for each of the available employees 30 is displayed through the customer account 41 in the form of a GPS-enabled map, wherein the GPS-enabled map shows the location of the nearest employees that offer the particular service 53 selected by the customer 40, as shown in FIG. 12. The on-demand service advertising system utilizes the GPS capabilities of the customer 40 device and the employee device of each of the available employees 30 to be able to determine the locations of the available employees 30 relative to the customer 40. The customer 40 will either manually set his or her location (using address information initially supplied upon sign up) or set the location automatically using the GPS of the customer 40 device. Using the GPS, the on-demand service advertising software will also determine the estimated time of arrival (ETA) or the estimated travel time from the current location of each of the available employees 30 to the current location of the customer 40.

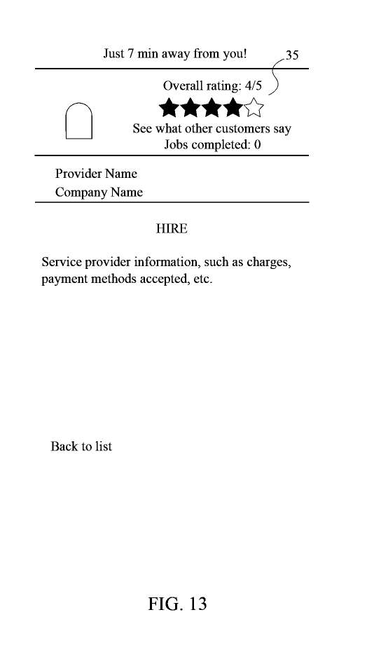

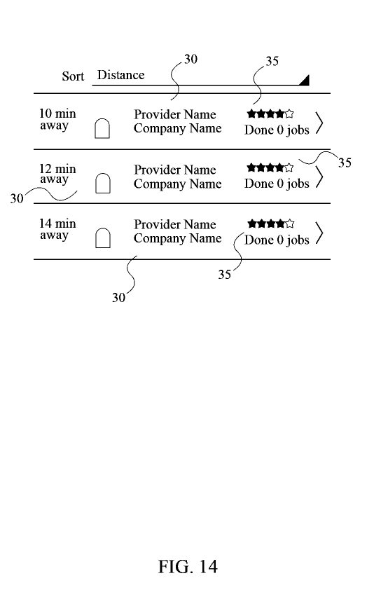

The customer 40 may press an available options button, which will cause the customer side 42 to present the customer 40 with a profile page of the nearest employee, as shown in FIG. 13, and an option to view the profile pages of the next closet employees that offer the same service, as shown in FIG. 14. The profile page will display information about the employee such as a digital photo, name, the service provider for which the employee is working, an overall employee rating 35 from previous customers, and the number of previous service requests completed by the employee. The profile page will also display textual notes of the service details and financial charges for the particular service 53, as decided upon by the service provider of the employee. A customer 40 may choose to request another employee, for example, if an employee has a low rating. If the customer 40 is satisfied with a specific employee 31 from the available employees 30, then the customer 40 may press an order button to send a service request to the employee device of the specific employee 31.

In reference to FIG. 2, once the service request for the specific employee 31 is received, the service request is sent to an employee account 32 linked to the specific employee 31. The specific employee 31 is required to log into the employee account 32 in order to access the employee side 33 of the on-demand service advertising software through the employee device. The specific employee 31 will be given a unique user identification (ID) and an employee password by the service provider for which the specific employee 31 is working. If the specific employee 31 forgets the employee password, the specific employee 31 may press a button that sends an e-mail notification to the service provider so that the specific employee 31 may be supplied with a new password. There may also be provided a help button that allows the specific employee 31 to view information about the on-demand service advertising system.

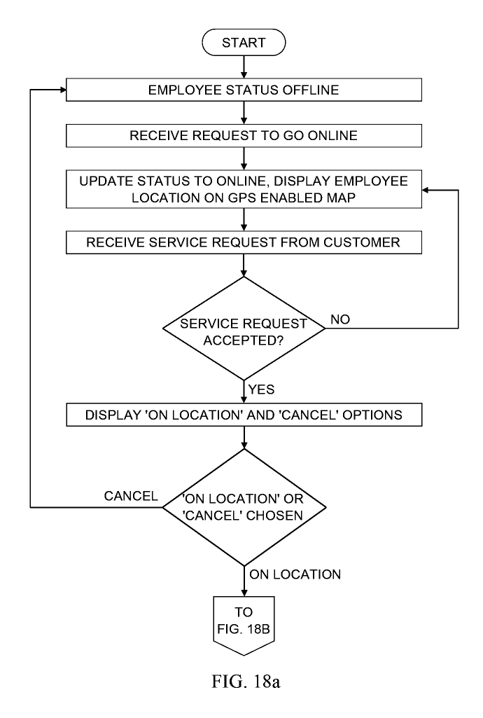

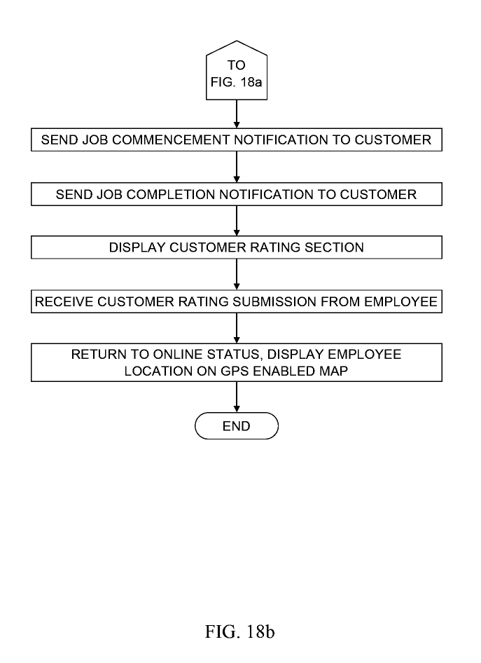

FIG. 18a and FIG. 18b show a flowchart illustrating the general process carried out by the employee side 33 of the on-demand service advertising system once the service request is received from the customer account 41. The process carried out by the employee side 33 generally involves: recognizing the status of the specific employee 31 as being offline; receiving a request by the specific employee 31 to go online; updating the status of the specific employee 31 to online, making the specific employee 31 available for receiving service requests from customers, and displaying the location of the specific employee 31 on a GPS enabled map; receiving the service request from the customer account 41; requiring the specific employee 31 to either accept or reject the service request; returning the status of the specific employee 31 to online if the service request is rejected; displaying on location and cancel options if the service request is accepted; returning the status of the specific employee 31 to offline if the cancel option is selected; sending a notification to the customer 40 stating that the job has been started if the on location option is selected; sending a notification to the customer 40 stating that the job has been finished; displaying a customer rating 44 section in which the employee rates the customer 40; receiving a submission for the rating of the customer 40 by the specific employee 31; and finally returning to the status of the specific employee 31 to online and displaying the location of the specific employee 31 on the GPS enabled map.

If the specific employee 31 is accessing the employee side 33 for the first time, the specific employee 31 will be required to upload a digital photo of him or herself. The digital photo is displayed to the customer 40 when viewing the available employees 30 and selecting the specific employee 31 in order to help identify the specific employee 31 when providing the particular service 53. Once logged in to the employee account 32, the employee side 33 initially sets the status for the specific employee 31 to offline. The system sets the employee account 32 such that the specific employee 31 is not displayed with the available employees 30 on the GPS-enabled map displayed to the customer account 41. In other words, while the status for the specific employee 31 is offline, they will not be listed as an available option for service requests.

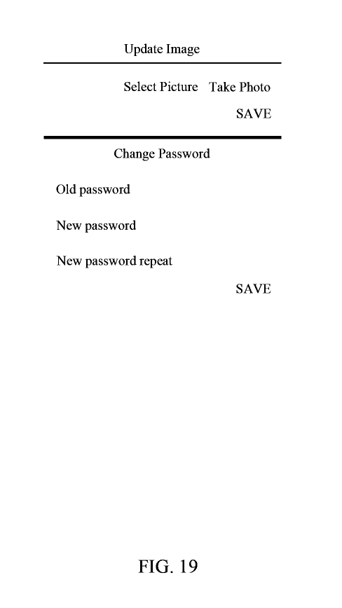

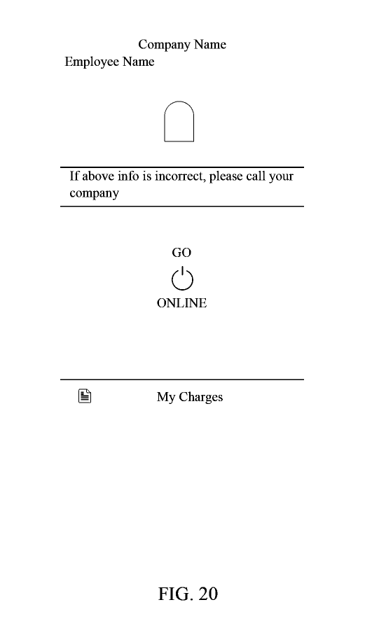

The specific employee 31 is presented with a list of option buttons, shown in FIG. 19-20, through the employee account 32. The list of option buttons includes a button to toggle the status of the specific employee 31 between online and offline, while other option buttons may include a my charges button, a change photo button, a change password button, and a sign out button. The my charges button allows the specific employee 31 to view previously completed service requests and details thereof. The change photo button allows the specific employee 31 to change the digital photo originally uploaded. The change password button allows the specific employee 31 to change the employee password, where the employee password (old) and the new password must be verified. The sign out button allows the specific employee 31 to exit or shut down the on-demand service advertising software on the employee device.

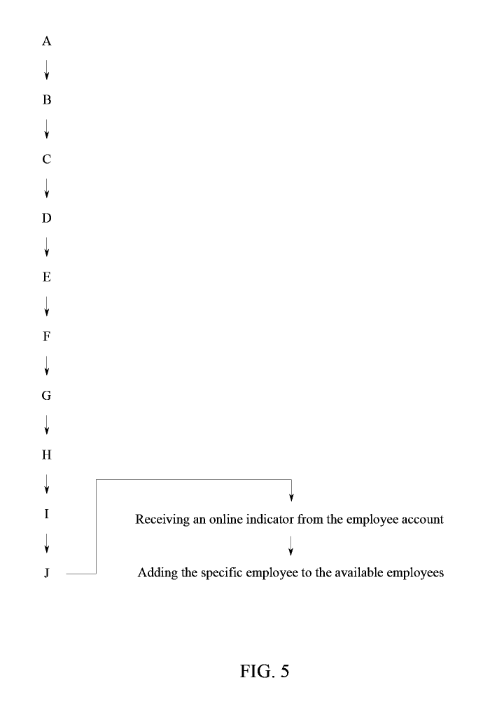

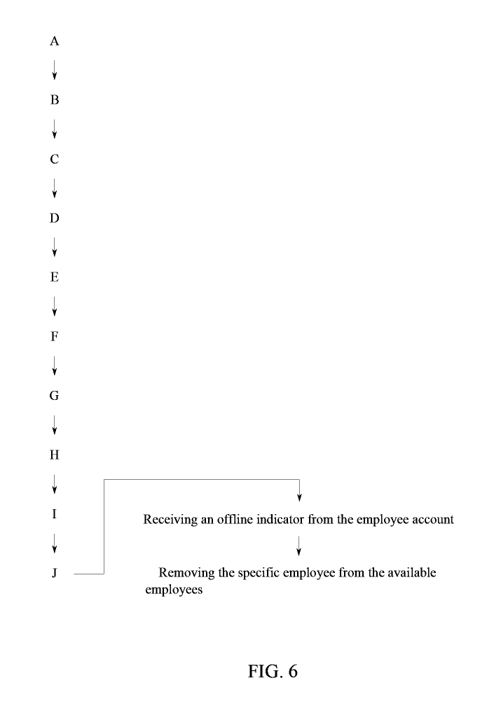

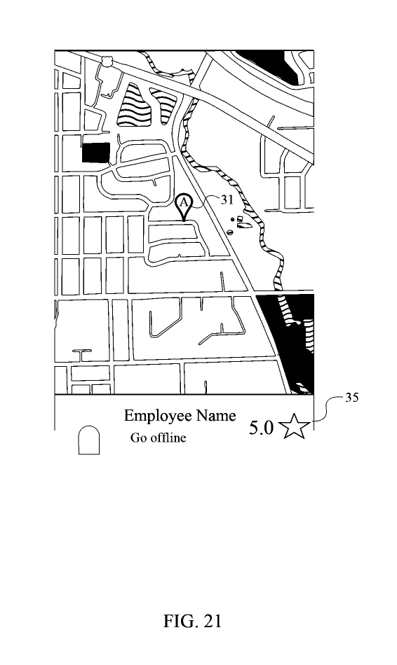

In reference to FIG. 5, if the specific employee 31 chooses to go online by pressing the go online button, an online indicator is sent to the administration side 10. Upon receiving the online indicator, the administration side 10 adds the employee account 32 for the specific employee 31 to the available employees 30. The specific employee 31 is then presented with a GPS-enabled map through the employee account 32 showing the current location of the specific employee 31, as shown in FIG. 21. The GPS-enabled map may also display such information as the employee's name, the digital photo of the specific employee 31, the overall employee rating 35 from previous customers, or a go offline button. In reference to FIG. 6, if the specific employee 31 chooses to go offline by pressing the go offline button, then an offline indicator is sent to the administration side 10. Upon receiving the offline indicator, the administration side 10 removes the employee account 32 for the specific employee 31 from the available employees 30, and returns the employee account 32 to the previous list of options described above and shown in FIG. 19-20. When the specific employee 31 is offline, the specific employee 31 is added to a directory of other employees that are offline. As the customer 40 views the available employees 30 for the particular service 53, the directory of offline employees will be displayed below the available employees 30, wherein the hire button is not displayed for the offline employees.

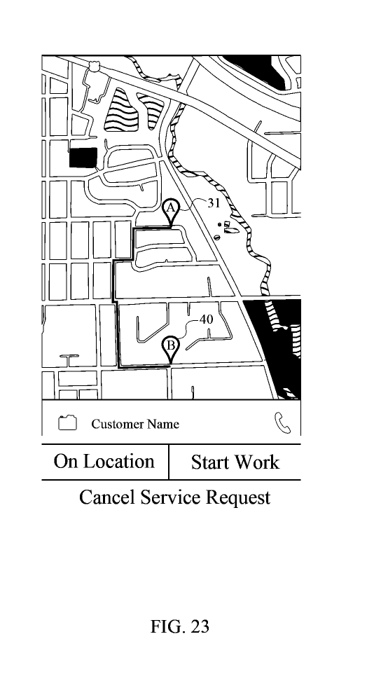

When the employee account 32 is online and receives the service request from the customer account 41, the GPS-enabled map on the employee device shows the location of the customer 40 and the ETA and/or distance of the customer 40 from the current location of the specific employee 31, as shown in FIG. 23. This corresponds to when the customer 40 presses the order button on the customer side 42. The GPS-enabled map on the employee device may also display the customer's name, address, and a customer rating 44 given to the customer 40 by other employees who have completed service requests for that customer 40. The specific employee 31 may then choose to either accept or decline the service request.

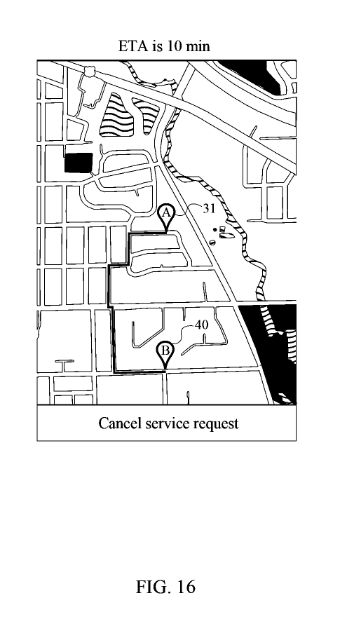

Similarly, when the specific employee 31 accepts the service request, the customer side 42 displays the GPS-enabled map on the customer 40 device, showing the live location and ETA of the specific employee 31, as shown in FIG. 16. Information for the specific employee 31 such as his or her name, phone number, and license plate number (if the specific employee 31 is driving a vehicle to the location of the customer 40) may also be displayed.

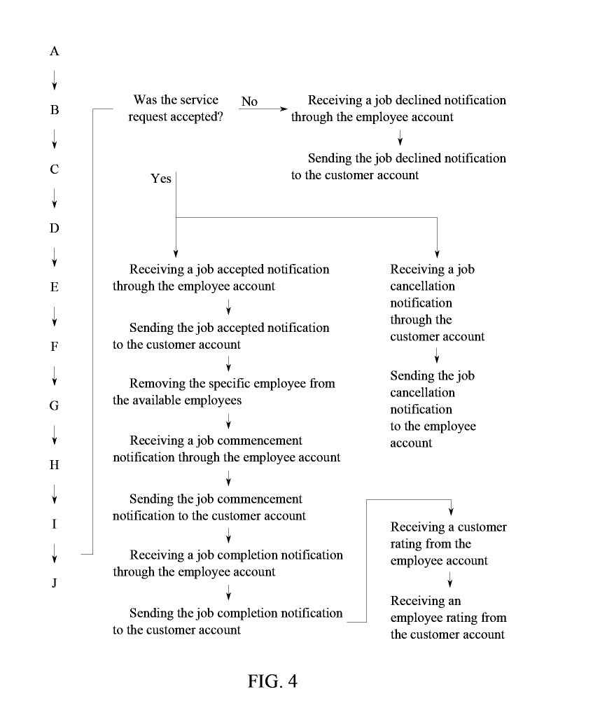

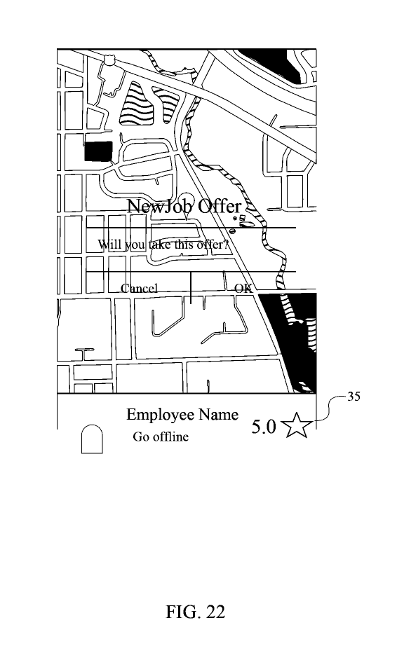

In order to accept the service request, the specific employee 31 must touch the screen of the employee device or press a button within a pre-determined amount of time, as depicted in FIG. 22. For example, when the service request is received, the specific employee 31 may have fifteen seconds to respond. If the specific employee 31 does not touch the screen or press a button to accept the service request within the pre-determined amount of time, then the service request is rejected. The specific employee 31 is then added to the available employees 30, wherein the status of the specific employee 31 remains online so that the specific employee 31 may respond to other service requests. The specific employee 31 may choose to ignore the service request, for example, if the customer 40 has an overall customer rating 45 that is low. In reference to FIG. 4, when the service request is rejected, a job declined notification is received through the employee account 32 and then sent to the customer account 41, such that the customer 40 is free to choose from the available employees 30 remaining. An e-mail notification is sent to the service provider stating that the specific employee 31 has rejected the service request. The service provider has the option to disable these notifications from the service provider side 20.

In further reference to FIG. 4, if the specific employee 31 touches the screen or presses a button to accept the service request, then the employee side 33 changes the status of the specific employee 31 to “busy” and the specific employee 31 is removed from the available employees 30. In this way, the specific employee 31 cannot be requested for service by other customers until the service request is either completed or canceled. Additionally, a job accepted notification is received through the employee account 32 and then sent to the customer account 41, such that the customer 40 is aware that the specific employee 31 has accepted the service request. The job accepted notification may also be forwarded to the service provider, wherein the service provider has the option to disable these notifications from the service provider side 20.

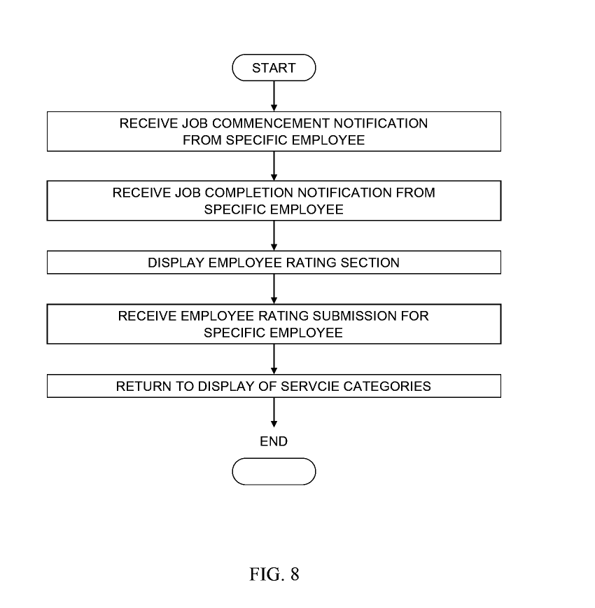

As shown in FIG. 23, accepting the service request causes the employee side 33 to display on location and cancel options to the specific employee 31 through the employee account 32. The specific employee 31 typically must travel from his or her current location to the location of the customer 40 in order to start the job for the service request. When the specific employee 31 arrives at the location of the customer 40, the specific employee 31 presses an on location button through the employee account 32 to send a notification to the customer 40 stating that the employee has arrived at the location of the customer 40. In reference to FIG. 4 and FIG. 8, once the on location button is pressed, a job commencement notification is received through the employee account 32 and sent to the customer account 41 in order to notify the customer 40 the job has been started.

The specific employee 31 is also provided with a cancellation button through the employee account 32, wherein the on location button may only be pressed if the cancel button has not been pressed. On the other hand, the cancel button may be pressed whether or not the on location button has been pressed. For example, the specific employee 31 may choose to cancel a job even after the job has been started after pressing the on location button. Canceling the service request ultimately returns the status of the specific employee 31 to offline, wherein the specific employee 31 is presented with the list of options shown in FIG. 19-20, at which point the specific employee 31 may choose to go back online.

If the cancel button is pressed, the employee side 33 may require the specific employee 31 to send an e-mail notification to the service provider explaining the reasons for the cancellation. The reasons for cancellation may be manually entered by the specific employee 31, or the reasons may be selected from a predefined list of reasons as determined by the administrator. Predefined reasons may include “customer not present at location” or “customer unable to pay for the service.” The service provider has the option to disable these notifications from the service provider side 20. Additionally, pressing the cancel button causes the employee side 33 to send a notification to the customer 40 stating that the service request has been canceled and may ask the customer 40 to request the service again from another employee.

The customer 40 is also provided with a cancel request button through the customer account 41, as shown in FIG. 16. The cancel request button allows the customer 40 to cancel the service request at any point in time. If the cancel request button is pressed, a job cancellation notification is received through the customer account 41 and sent to the employee account 32 and the service provider account stating that the service request has been canceled. Preferably the job cancellation notification is an e-mail notification, however, the job cancellation notification can be any type of electronic notification. The job cancellation notification may specify the customer 40 who canceled the service request, the name of the specific employee 31 who was originally requested for the particular service 53, and the reason for the cancellation.

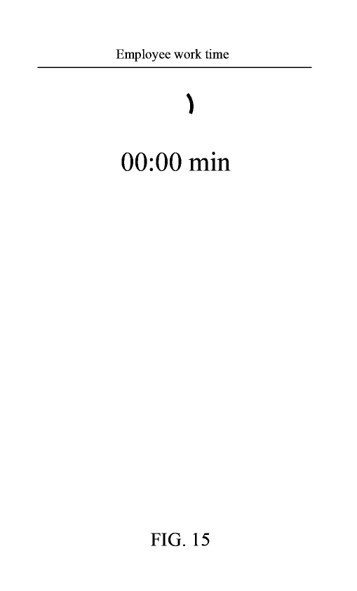

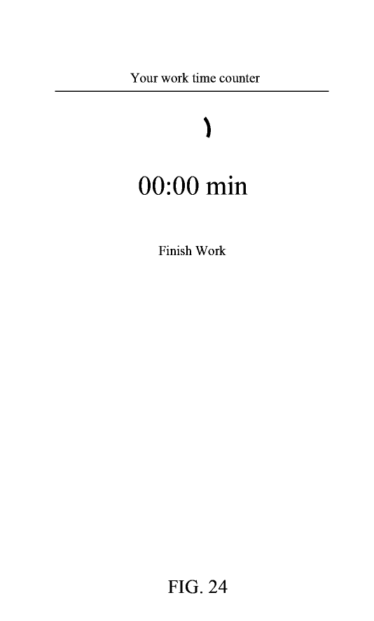

In reference to FIG. 4 and FIG. 8, if neither the customer 40 nor the specific employee 31 cancels the service request, then the specific employee 31 continues the job until it has been completed. An employee work time may be displayed throughout the completion of the job through both the customer side 42 and the employee side 33, as shown in FIG. 15 and FIG. 24 respectively. When the service request has been completed, the specific employee 31 may press a button to notify the employee side 33 that the job has been finished. A job completion notification is then received through the employee account 32 and sent to the customer account 41 and the service provider account in order to notify both the customer 40 and the service provider that the service request has been completed. The job completion notification can be an e-mail notification, or any other type of electronic notification. The service provider has the option to disable these notifications through the service provider side 20.

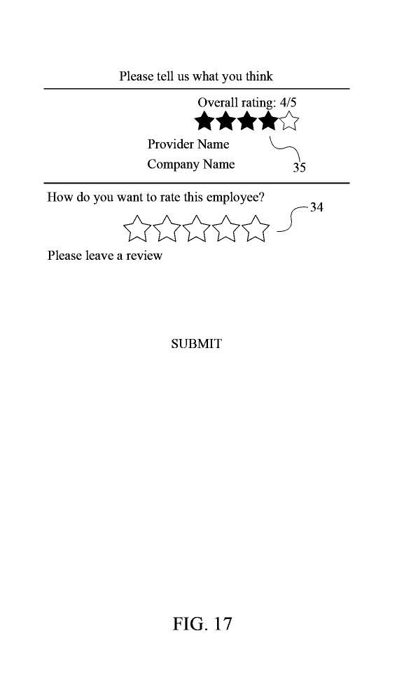

In reference to FIG. 8, when the job has been completed, the customer 40 is presented with an employee rating 34 section in which the customer 40 rates the specific employee 31, as shown in FIG. 17. The employee rating 34 section may show a digital photo of the specific employee 31, the employee's name, and the overall employee rating 35 of the specific employee 31. The customer 40 may manually select an employee rating 34 for the specific employee 31 based on the quality of service that was provided. For example, the rating system may utilize a number of stars out of five or other arbitrary number. The employee rating 34 is then sent from the customer account 41 to the administration account, wherein the administration account receives the employee rating 34 and aggregates the employee rating 34 into the overall employee rating 35 for the specific employee 31.

If the employee rating 34 for the specific employee 31 submitted by the customer 40 is above a threshold amount (e.g., four or more stars out of five), indicating that the customer 40 was satisfied with the service, then the customer 40 is returned to the display of the service categories 50. If the employee rating 34 for the specific employee 31 submitted by the customer 40 is below the threshold amount (e.g., less than four stars out of five), indicating that the customer 40 was dissatisfied with the service, then the customer 40 may be required to submit a note detailing the reasons for the low rating before being returned to the display of the service categories 50. The service provider may choose to enable or disable this requirement and thus choose whether or not the service provider receives any notes regarding low customer ratings of employees. In either case of the employee rating 34 being above or below the threshold amount, the customer 40 is returned to the display of the service categories 50, indicating that the service request has been completed. From this point, the process of the customer side 42 may be repeated or the customer 40 may log out of the on-demand service advertising software.

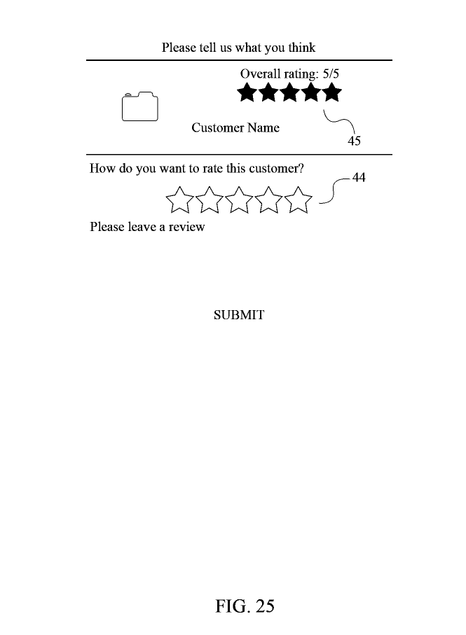

In reference to FIG. 18b, similar to the customer side 42, when the job has been finished, the specific employee 31 is presented with a customer rating 44 section in which the specific employee 31 rates the customer 40, as shown in FIG. 25. The customer rating 44 section may show a digital photo of the customer 40, the customer's name and phone number, and the overall customer rating 45 of the customer 40. The specific employee 31 may manually select a customer rating 44 for the customer 40 based on the experience of the specific employee 31 while completing the service request. For example, the rating system may utilize a number of stars out of five or other arbitrary number. The customer rating 44 is then sent from the employee account 32 to the administration account, wherein the administration account receives the customer rating 44 and aggregates the customer rating 44 into the overall customer rating 45 for the customer 40.

If the customer rating 44 for the customer 40 submitted by the specific employee 31 is above a threshold amount (e.g., four or more stars out of five), indicating that the specific employee 31 had a positive experience with the customer 40, then the status for the specific employee 31 is returned to online and the specific employee 31 is once again presented with the GPS-enabled map showing the current location of the specific employee 31, as shown in FIG. 21. If the customer rating 44 for the customer 40 submitted by the specific employee 31 is below the threshold amount (e.g., less than four stars out of five), indicating that the specific employee 31 had a negative experience with the customer 40, the specific employee 31 may be required to submit a note to the service provider detailing the reasons for the low rating before the status of the specific employee 31 is returned to online and the specific employee 31 is presented with the GPS-enabled map. The service provider may choose to enable or disable this requirement and thus choose whether or not the service provider receives any notes regarding low employee ratings of customers. In either case, the status of the specific employee 31 is returned to online and the specific employee 31 is presented with the GPS-enabled map showing the current location of the specific employee 31, indicating that the service request has been completed. From this point, the process of the employee side 33 may be repeated or the specific employee 31 may log out of the on-demand service advertising software.

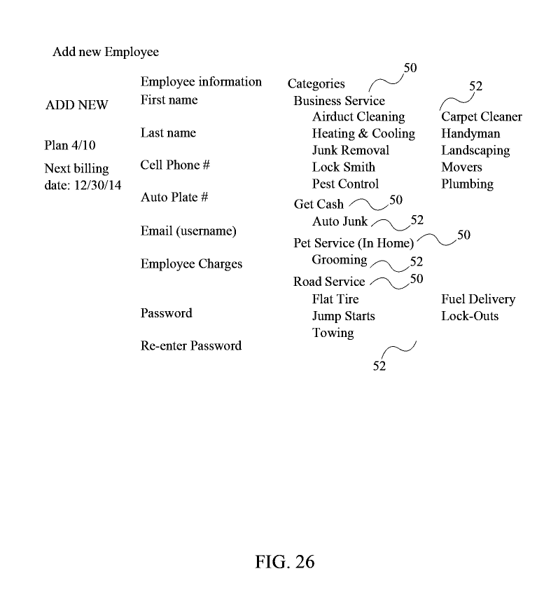

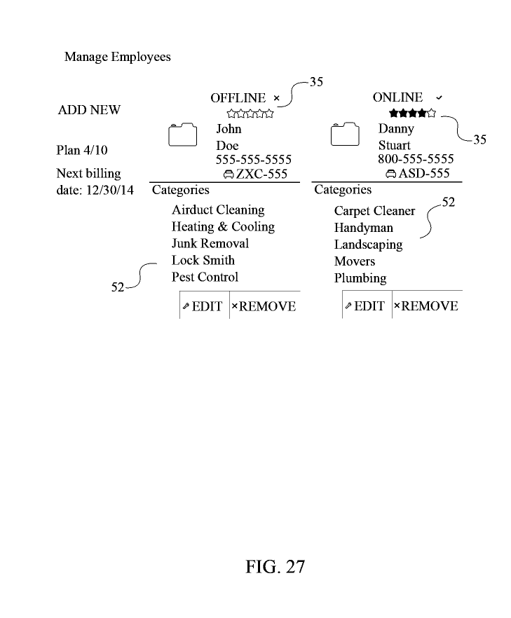

The service provider side 20 will be described with reference to FIG. 26-27. FIG. 26-27 show example GUI displays of the service provider side 20 of the on-demand service advertising system. The service provider side 20 is primarily a control panel from which the service providers may control various aspects of the employee accounts for the employees of the service provider through the on-demand service advertising software and utilize information received from both the employee side 33 and the customer side 42. The service provider side 20 has a home section, which displays a main graphic for the service provider side 20 GUI, which is controlled and edited from the administration side 10. Each of the service providers has the options to sign up with the system, log in, or press a help button to access more information about the on-demand service advertising system.

The service provider is required to sign up when accessing the on-demand service advertising software for the first time. Typically, a user, such as an employee or company head of the service provider, will sign up for the system on behalf of the service provider. Service provider information, supplied by the user, may include a company name, address, city, state, postal code, phone numbers, extensions, fax numbers, name of the user applying on behalf of the service provider, a direct phone number to the user applying on behalf of the service provider, a service provider e-mail address, and a service provider password. The sign up section may also require that the user indicate how many employees the service provider wishes to sign up. The service provider may be charged a fee for signing up with the system based on the number of employees the service provider wishes to sign up. The service provider may also be required to accept a terms of use agreement as determined and edited by the administrator.

In the preferred embodiment of the present invention, once all the service provider information is provided, the service provider will be required to submit the service provider information as an application for access and use of the on-demand service advertising software. The application is sent to the administration side 10, wherein the administrator may review the service provider information. The administrator may then choose to approve or reject the application for the service provider based on the validity and verifiability of the service provider information supplied. If the administrator approves the application for the service provider, then the administration side 10 sends an e-mail to the service provider side 20 to notify the service provider that the application has been approved and the service provider account for the service provider has been created within the system.

If the service provider has been approved by the administrator, then the service provider may log into the service provider side 20 of the on-demand service advertising system through the log in section. The service provider will be required to enter the service provider e-mail address and the service provider password supplied upon sign up to log in. The service provider password may be changed, upon verification through the administration side 10, if the service provider forgets the service provider password.

When logged into the on-demand service advertising software, the service provider is presented with a main control panel. From the main control panel, the service provider has the option to add and manage employees as shown in FIG. 27, change the service provider account plan, view the service provider information that was initially supplied upon sign up, log out of the service provider side 20, or press a help button.

If the service provider wishes to create an account for one or more of the employees of the service provider, the service provider may access an add employee section, as shown in FIG. 26. The service provider may be required to supply an employee's first name, last name, phone number, license plate number (if applicable), a user name, and a password. For each employee, the service provider may selectively choose various notifications and alerts to be received from each of the employees and the customers of each of the employees. For example, the service provider may choose to enable or disable the reception of notifications when the employees go online, sign out of the employee side 33, change his or her photo, change a note, or change his or her password. Additionally, the service provider may choose to enable or disable the reception of notifications when the employees accept service requests, reject service requests, cancel service requests after initially accepting the service requests, start service requests, finish service requests, rate a customer 40, and supply a note with a low customer rating 44, and when a customer 40 cancels a service request, rates an employee, and supplies a note with a low employee rating 34. The service provider may also select the category or categories of service for which the employee is qualified to complete service requests. A cancel button may be pressed to cancel the addition of a new employee, or an add employee button may be pressed to register the employee's account and return to the main control panel.

If the service provider wishes to manage the employee account 32 for each of the employees on the employee side 33, the service provider may access a manage employees section, as shown in FIG. 27. The manage employees section displays a list of all the employees of the service provider registered with the on-demand service advertising system. In the manage employees section, the service provider may search for any one of the employees of the service provider from the list of all the employees through a keyword search function.

From the manage employees section, the service provider may edit the information for any of the employees through an edit employee section similar to the add employee section shown in FIG. 26. From the edit employee section, the service provider may be able to: edit employee information (e.g., name, phone numbers, license plate number, etc.); reset the employee password to the employee side 33 for an employee; change the status of an employee (e.g., active or suspended from duty); view and edit notes and completed service requests for an employee; view logs of an employee's activity on the system (e.g., reports of log in and log out times, service requests accept and rejected, the employee rating 34 given from individual customers for the employee and notes associated with low ratings, the customer rating 44 given to customers by the employee, categories of service for the service requests completed by the employee, etc.); or delete the employee account 32 for an employee on the on-demand service advertising system.

The administration side 10 is accessed only by the administrator that owns and operates the on-demand service advertising system. The administration side 10 gives the administrator the ability to control various aspects of the customer side 42, the employee side 33, and the service provider side 20 of the on-demand service advertising software. As previously mentioned, the service categories 50 may be added, removed, or edited at will by the administrator through the administrator account on the administration side 10.

For the customer side 42, the administrator may have the ability to: search for any customer; edit customer information; suspend a customer from using the system if many employees complain about the customer and/or give the customer low ratings; edit the overall customer rating 45 of a customer; control and edit the information available through help buttons; create and edit a terms of use agreement; and edit predefined and selectable reasons for a customer to cancel a service request.

For the employee side 33, the administrator may have the ability to: search for any employee; edit employee information; suspend an employee from using the system if many customers complain about the employee and/or give the employee low ratings; control and edit the information available through help buttons; edit customer ratings of an employee; and edit predefined and selectable reasons for a employee to cancel a service request.

For the service provider side 20, the administrator may have the ability to: create main page graphics for the home section; control and edit the information available through help buttons; approve or reject service provider sign up applications; modify the sign up requirements; create and edit a terms of use agreement; search for any service provider; add or remove employees on behalf of a service provider; approve the service categories 50 for which a service provider is qualified to provide service; and bill a service provider for the usage of the on-demand service advertising system.

These abilities of the administrator are included by way of example and are not intended to limit the aspects of the on-demand service advertising software that the administrator may control through the administration side 10. The administrator may have the ability to control other aspects of the system not specifically listed herein.

Although the invention has been explained in relation to its preferred embodiment, it is to be understood that many other possible modifications and variations can be made without departing from the spirit and scope of the invention as hereinafter claimed.

What is claimed is:

1. A method for providing on-demand service advertising by executing computer-executable instructions stored on a non-transitory computer-readable medium, the method comprises the steps of:
providing an employee device, wherein an employee account is operated on the employee device;
providing a customer device, wherein a customer account is operated on the customer device;
receiving a service selection for a particular service through the customer account;
displaying a plurality of available employees through the customer account;
receiving a service request for a specific employee from the available employees;
sending the service request to the employee account, wherein the employee account is linked to the specific employee;
receiving a service response from the employee account; and
sending the service response to the customer account.

2. The method for providing on-demand service advertising by executing computer-executable instructions stored on a non-transitory computer-readable medium, the method as claimed in claim 1 further comprises the steps of:
receiving an employee rating from the customer account.

3. The method for providing on-demand service advertising by executing computer-executable instructions stored on a non-transitory computer-readable medium, the method as claimed in claim 1 further comprises the steps of:
receiving a customer rating from the employee account.

4. The method for providing on-demand service advertising by executing computer-executable instructions stored on a non-transitory computer-readable medium, the method as claimed in claim 1 further comprises the steps of:
receiving a job cancellation notification through the customer account,
if the service request is accepted by the specific employee; and
sending the job cancellation notification to the employee account.

5. The method for providing on-demand service advertising by executing computer-executable instructions stored on a non-transitory computer-readable medium, the method as claimed in claim 1 further comprises the steps of:
receiving a job declined notification through the employee account,
if the service request is declined by the specific employee; and
sending the job declined notification to the customer account.

6. The method for providing on-demand service advertising by executing computer-executable instructions stored on a non-transitory computer-readable medium, the method as claimed in claim 5, wherein the job declined notification is automatically sent after a pre-determined amount of time from receiving the service request.

7. The method for providing on-demand service advertising by executing computer-executable instructions stored on a non-transitory computer-readable medium, the method as claimed in claim 1 further comprises the steps of:
receiving a job accepted notification through the employee account,
if the service request is accepted by the specific employee; and
sending the job accepted notification to the customer account.

8. The method for providing on-demand service advertising by executing computer-executable instructions stored on a non-transitory computer-readable medium, the method as claimed in claim 1 further comprises the steps of:
receiving a job commencement notification through the employee account,
if the service request is accepted by the specific employee; and
sending the job commencement notification to the customer account.

9. The method for providing on-demand service advertising by executing computer-executable instructions stored on a non-transitory computer-readable medium, the method as claimed in claim 1 further comprises the steps of:
receiving a job completion notification through the employee account,
if the service request is accepted by the specific employee; and
sending the job completion notification to the customer account.

10. The method for providing on-demand service advertising by executing computer-executable instructions stored on a non-transitory computer-readable medium, the method as claimed in claim 1 further comprises the steps of:
receiving an online indicator from the employee account; and
adding the specific employee to the available employees.

11. The method for providing on-demand service advertising by executing computer-executable instructions stored on a non-transitory computer-readable medium, the method as claimed in claim 1 further comprises the steps of:
receiving an offline indicator from the employee account; and
removing the specific employee from the available employees.

12. The method for providing on-demand service advertising by executing computer-executable instructions stored on a non-transitory computer-readable medium, the method as claimed in claim 1 further comprises the steps of:
removing the specific employee from the available employees,
if the service request is accepted by the specific employee.

13. The method for providing on-demand service advertising by executing computer-executable instructions stored on a non-transitory computer-readable medium, the method as claimed in claim 1 further comprises the steps of:
displaying location data for the customer account through the employee account.

14. The method for providing on-demand service advertising by executing computer-executable instructions stored on a non-transitory computer-readable medium, the method as claimed in claim 1 further comprises the steps of:
displaying location data for the available employees through the customer account.

15. The method for providing on-demand service advertising by executing computer-executable instructions stored on a non-transitory computer-readable medium, the method as claimed in claim 1 further comprises the steps of:
displaying a plurality of service categories through the customer account;
receiving a category selection for a selected category from said service categories through the customer account; and
displaying a plurality of specific services for the selected category through the customer account, wherein the particular service is selected from said specific services.

16. A method for providing on-demand service advertising by executing computer-executable instructions stored on a non-transitory computer-readable medium, the method comprises the steps of:
providing an employee device, wherein an employee account is operated on the employee device;
providing a customer device, wherein a customer account is operated on the customer device;
displaying a plurality of service categories through the customer account;
receiving a category selection for a selected category from said service categories through the customer account;
displaying a plurality of specific services for the selected category through the customer account;
receiving a service selection for a particular service from said specific services through the customer account;
displaying a plurality of available employees through the customer account;
receiving a service request for a specific employee from the available employees;
sending the service request to the employee account, wherein the employee account is linked to the specific employee;
receiving a job accepted notification through the employee account,
if the service request is accepted by the specific employee;
sending the job accepted notification to the customer account;
removing the specific employee from the available employees;
receiving a job commencement notification through the employee account;
sending the job commencement notification to the customer account;
receiving a job completion notification through the employee account; and
sending the job completion notification to the customer account.

17. The method for providing on-demand service advertising by executing computer-executable instructions stored on a non-transitory computer-readable medium, the method as claimed in claim 16 further comprises the steps of:
receiving an employee rating from the customer account.

18. The method for providing on-demand service advertising by executing computer-executable instructions stored on a non-transitory computer-readable medium, the method as claimed in claim 16 further comprises the steps of:
receiving a customer rating from the employee account.

19. The method for providing on-demand service advertising by executing computer-executable instructions stored on a non-transitory computer-readable medium, the method as claimed in claim 16 further comprises the steps of:
receiving a job cancellation notification through the customer account; and
sending the job cancellation notification to the employee account.

20. The method for providing on-demand service advertising by executing computer-executable instructions stored on a non-transitory computer-readable medium, the method as claimed in claim 16 further comprises the steps of:
displaying location data for the customer account through the employee account; and
displaying location data for the available employees through the customer account.
